(19) United States
(12) Patent Application Publication
(10) Pub. No.: US 2021/0088272 A1
(43) Pub. Date: Mar. 25, 2021

(54) REFRIGERATOR APPLIANCES AND METHODS FOR SELECTIVELY LOCKING A SUB-ENCLOSURE THEREIN

(71) Applicant: Haier US Appliance Solutions,Inc., Wilmington, DE (US)

(72) Inventors: Choon Jae Ryu, Prospect, KY (US); Michael Goodman Schroeder, Louisville, KY (US); Stephanos Kyriacou, Lousiville, KY (US)

(21) Appl. No.: 16/582,085

(22) Filed: Sep. 25, 2019

(51) Int. Cl. F25D 29/00; G06Q 10/08

(52) U.S. Cl. CPC F25D 29/00; F25D 2700/06; F25D 2700/04; G06Q 10/087

(57) ABSTRACT

A refrigerator appliance, as provided herein, may include a cabinet, a door rotatably hinged to the cabinet, a user-detection assembly mounted to the cabinet, a sub-enclosure, and a controller. The sub-enclosure may define a storage volume and may be mounted to the cabinet. The sub-enclosure may include an electric lock assembly actuatable between a locked state restricting access to the storage volume and an unlocked state permitting access to the storage volume. The controller may be operably coupled to the user-detection assembly. The controller may be configured to initiate an operation routine. The operation routine may include receiving a purchase invoice, receiving a marker signal from the user-detection assembly, detecting a specific user based on the marker signal, determining the specific user corresponds to the purchase invoice, and directing the sub-enclosure to the unlocked state in response to determining the specific user corresponds to the purchase invoice.

### FIELD OF THE INVENTION

The present subject matter relates generally to generally to tracking and locking items within a storage enclosure, such as a refrigerator appliance.

### BACKGROUND OF THE INVENTION

Storage enclosures, such as refrigerator appliances and pantries, generally provide an enclosed chamber for receiving multiple items or objects. For example, refrigerator appliances generally include a cabinet that defines a chilled chamber. A user can place certain items or objects within the chilled chamber in order to hinder perishing of such items. Thereby, a useable life of perishable items or objects can be increased.

Over time, a large volume or number of stored items (e.g., food items, medications, vitamins, etc.) can accumulate within the refrigerator's chilled chamber. As stored items accumulate, users of the refrigerator appliance can have difficulty identifying the items located within the refrigerator appliance. Additionally, user can also have difficulty determining a quantity of certain items within the refrigerator appliance. These difficulties can be magnified and be of greater concern when dealing with items such as medications. Moreover, these difficulties can be magnified if multiple users add/remove items from a common refrigerator appliance. Consequently, the users may accidentally take or forget to take certain items in a timely manner. Additionally or alternatively, some users may be unaware that certain items have been removed or consumed. Thus, users may fail to replace or replenish such items.

Some attempts to address these issues have included systems that require a user to manually separate items (e.g., medication or vitamins) and place them within dedicated enclosures, such as daily boxes. Unfortunately, these are often cumbersome. For instance, existing systems often require significant physical and mental effort to ensure the correct items are taken by a correct user. If one or more caregivers are responsible for medicating a dependent or patient, for example, the caregivers cannot always be sure that medications are taken as directed. Moreover, if the items are perishable, it can be difficult to ensure items are taken/consumed before they expire.

Aside from ensuring items are consumed correctly, it may be important to ensure that certain items are not accessed by an inappropriate party (e.g., someone who is not a caregiver or patient).

Accordingly, a refrigerator appliance with features for assisting a user with tracking contents of a chilled chamber of the refrigerator appliance would be useful. In particular, a refrigerator appliance with features for securing certain items, such as medications, within a chilled chamber of the refrigerator appliance would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a refrigerator appliance is provided. The refrigerator appliance may include a cabinet, a door rotatably hinged to the cabinet, a user-detection assembly mounted to the cabinet, a sub-enclosure, and a controller. The sub-enclosure may define a storage volume and may be mounted to the cabinet. The sub-enclosure may include an electric lock assembly actuatable between a locked state restricting access to the storage volume and an unlocked state permitting access to the storage volume. The controller may be operably coupled to the user-detection assembly. The controller may be configured to initiate an operation routine. The operation routine may include receiving a purchase invoice, receiving a marker signal from the user-detection assembly, detecting a specific user based on the marker signal, determining the specific user corresponds to the purchase invoice, and directing the sub-enclosure to the unlocked state in response to determining the specific user corresponds to the purchase invoice.

In another exemplary aspect of the present disclosure, a method of operating a refrigerator appliance is provided. The method may include receiving a purchase invoice and receiving a marker signal from a user-detection assembly of the refrigerator appliance. The method may further include detecting a specific user based on the marker signal and determining the specific user corresponds to the purchase invoice. The method may still further include directing the sub-enclosure to the unlocked state in response to determining the specific user corresponds to the purchase invoice.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a refrigerator appliance according to exemplary embodiments of the present disclosure.

FIG. 2 provides a front elevation view of a refrigerator appliance according to exemplary embodiments of the present disclosure, wherein refrigerator doors are shown in an open position.

FIG. 3 provides a schematic view of a refrigerator appliance according to exemplary embodiments of the present disclosure.

FIG. 4 provides a flow chart illustrating a method of operating a refrigerator appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Generally, the present disclosure provides methods to aid in securing certain items, such as medications and vitamins, within a storage enclosure, such as a refrigerator appliance or pantry. The methods may include one or more steps for determining what items (i.e., medications) are being added or removed from the storage enclosure. A sub-enclosure, such as a drawer or bin, within the storage enclosure can be selectively locked and unlocked by specific users to keep the items secure and ensure that the items are properly identified/tracked.

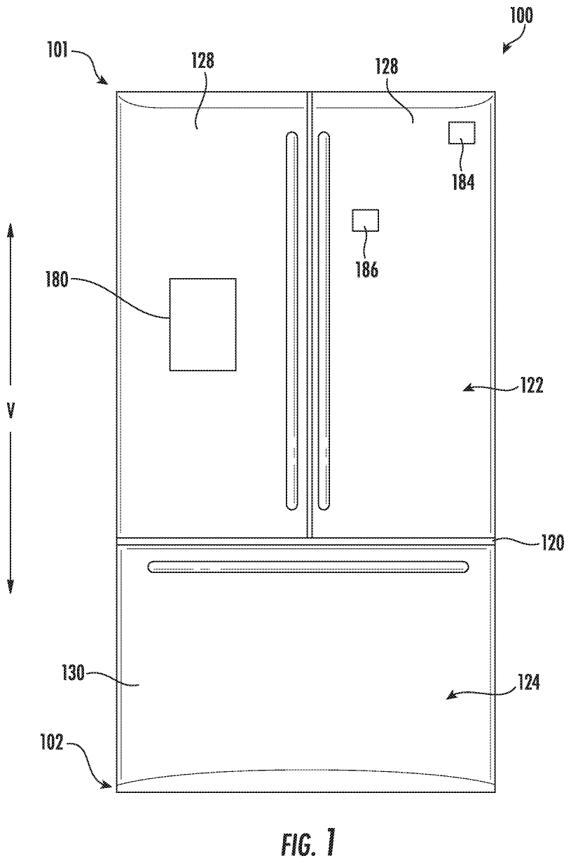

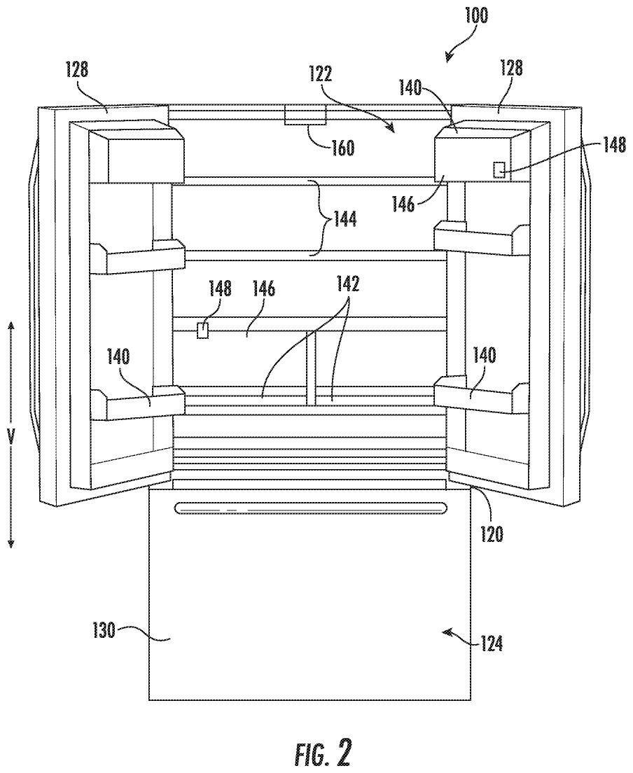

Turning now to the figures, FIG. 1 provides a front elevation view of a refrigerator appliance 100 according to exemplary embodiments of the present disclosure with refrigerator doors 128 of the refrigerator appliance 100 shown in a closed position. FIG. 2 provides a front view elevation of refrigerator appliance 100 with refrigerator doors 128 shown in an open position to reveal a fresh food chamber 122 of refrigerator appliance 100.

Refrigerator appliance 100 includes a housing or cabinet 120 that extends between a top 101 and a bottom 102 along a vertical direction V. Cabinet 120 defines chilled chambers for receipt of food items for storage. In particular, cabinet 120 defines fresh food chamber 122 positioned at or adjacent top 101 of cabinet 120 and a freezer chamber 124 arranged at or adjacent bottom 102 of cabinet 120. As such, refrigerator appliance 100 is generally referred to as a bottom mount refrigerator. It is recognized, however, that the benefits of the present disclosure apply to other types and styles of storage enclosure, such as a top mount refrigerator appliance, a side-by-side style refrigerator appliance, or an unrefrigerated pantry enclosure. Consequently, the description set forth herein is for illustrative purposes only and is not intended to be limiting in any aspect to any particular storage enclosure or refrigerator chamber configuration.

Refrigerator doors 128 are rotatably hinged to an edge of cabinet 120 for selectively accessing fresh food chamber 122. In addition, a freezer door 130 is arranged below refrigerator doors 128 for selectively accessing freezer chamber 124. Freezer door 130 is coupled to a freezer drawer 142 (not shown) slidably mounted within freezer chamber 124. As discussed above, refrigerator doors 128 and freezer door 130 are shown in the closed configuration in FIG. 1, and refrigerator doors 128 are shown in the open position in FIG. 2.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted to the cabinet 120 (e.g., directly or indirectly via a door 128) within fresh food chamber 122. Bins 140, drawers 142, and shelves 144 are configured for receipt of stored items (e.g., food items, medications, or vitamins) and may assist with organizing such stored items. As an example, drawers 142 can receive perishable items (e.g., vegetables, fruits, cheeses, or medications) and increase the useful life of such items.

As described in greater detail below, one or more of the bins 140 or drawers 142 may be provided as a lockable sub-enclosure 146 that defines a storage volume and has an electric locking assembly 148. Generally, the locking assembly 148 can be any suitable structure for holding the respective sub-enclosure 146 closed and preventing the storage volume from being accessed. Thus, the locking assembly 148 is actuatable between a lock state restricting access to the storage volume and an unlocked state permitting access to the storage volume.

Refrigerator appliance 100 may also include features for assisting a user with identifying stored items positioned within fresh food chamber 122 or freezer chamber 124. The user can utilize such features, for example, to view items stored within fresh food chamber 122 or freezer chamber 124 or create an inventory of such food items.

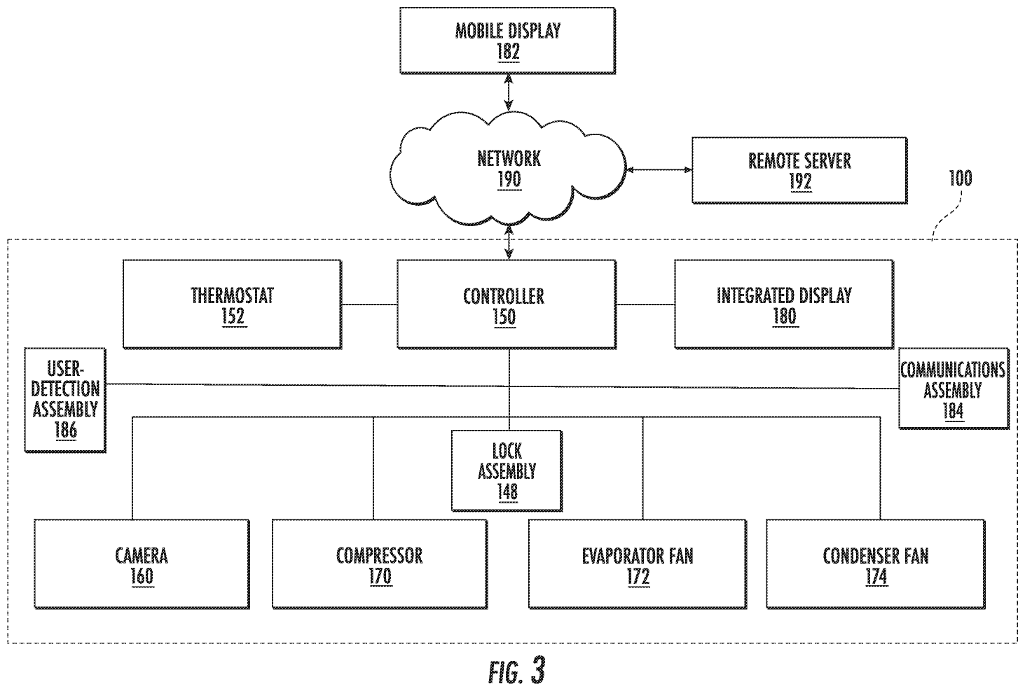

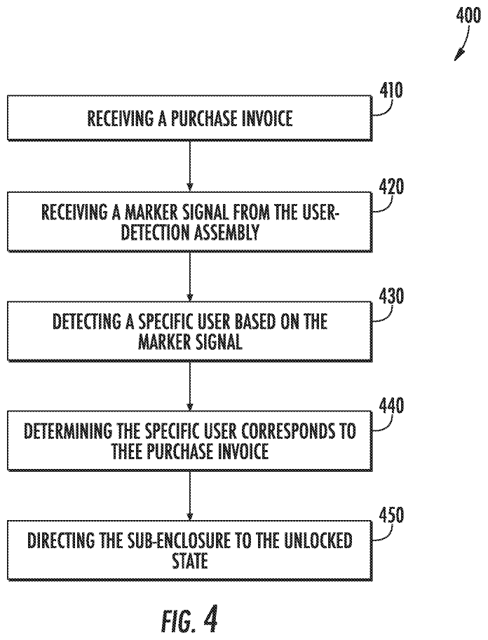

FIG. 3 provides a schematic view of refrigerator appliance 100. Refrigerator appliance 100 includes a controller 150 that is operatively coupled or in communication with components of a refrigeration system (not shown) of refrigerator appliance 100 configured for cooling fresh food chamber 122 or freezer chamber 124. The components include a compressor 170, an evaporator fan 172, and a condenser fan 174. Controller 150 can selectively operate such components in order to cool fresh food chamber 122 or freezer chamber 124. Controller 150 is also in communication with a thermostat (e.g., a thermocouple or thermistor). The thermostat may be positioned in fresh food compartment 122 or freezer compartment 124 (FIG. 2). Controller 150 may receive a signal from the thermostat that corresponds to a temperature of fresh food compartment 122 or freezer compartment 124. Controller 150 may also include an internal timer for calculating elapsed time periods. Controller 150 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes non-transitory programming instructions stored in memory. For certain embodiments, the instructions include a software package configured to operate appliance 100 or execute an operation routine (e.g., the exemplary method 400 described below with reference to FIG. 4). The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout refrigerator appliance 100. Input/output (“I/O”) signals may be routed between controller 150 and various operational components of refrigerator appliance 100. One or more components of refrigerator appliance 100 may be in communication (e.g., electric communication) with controller 150 via one or more conductive signal lines or shared communication busses. Additionally or alternatively, one or more components of refrigerator appliance 100 may be in communication (e.g., wireless communication) with controller 150 via one or more wireless signal bands.

In some embodiments, refrigerator appliance 100 also includes a camera or camera module 160. Camera 160 may be any type of device suitable for capturing a two-dimensional picture or image. As an example, camera 160 may be a video camera or a digital camera with an electronic image sensor [e.g., a charge coupled device (CCD) or a CMOS sensor]. When assembled, camera 160 is in communication (e.g., electric or wireless communication) with controller 150 such that controller 150 may receive a signal from camera 160 corresponding to the image captured by camera 160.

Generally, camera 160 is positioned on refrigerator appliance 100. In some embodiments, camera 160 is mounted within fresh food chamber 122 at a top portion thereof (e.g., adjacent top 101). For instance, camera 160 may be fixed to or directed through a top wall of an internal liner defining fresh food chamber 122. In such embodiments, camera 160 may be directed downward, as illustrated in FIG. 2.

In certain embodiments, is directed toward one or more chilled chamber (e.g., fresh food chamber 122—FIG. 2). For instance, camera 160 may be directed towards at least a portion of any particular one of or combination of drawers 142 and shelves 144 (FIG. 2). Thus, camera 160 can capture images of one of drawers 142, all of drawers 142, one of shelves 144, all of shelves 144, or any suitable combination thereof.

Although camera 160 is illustrated as being mounted within fresh food chamber 122, it is understood that additional or alternative embodiments include a camera assembly [e.g., digital camera with an electronic image sensor [e.g., a charge coupled device (CCD) or a CMOS sensor] mounted at another suitable portion of refrigerator appliance, such as a door 128. Such a camera assembly may be directed outward or in front of refrigerator appliance 100 and may thus capture images of a user or area positioned forward from refrigerator appliance 100 (e.g., when the corresponding door is in a closed position).

In certain embodiments, refrigerator appliance 100 includes an integrated display 180. Integrated display 180 may be mounted on refrigerator door 128 (FIG. 1) or at any other suitable location on refrigerator appliance 100. Integrated display 180 is in communication with controller 150 such that integrated display 180 may receive a signal from controller 150 (e.g., corresponding to an image captured by camera 160). Integrated display 180 can receive such signal from controller 150 and present the image to a user visually. Integrated display 180 may include, for example, a liquid crystal display panel (LCD), a plasma display panel (PDP), or any other suitable mechanism for displaying an image (e.g., a projector).

Separate from or in addition to integrated display 180, refrigerator 100 may include a communications assembly 184 in communication with controller 150. Generally, communications assembly 184 may be mounted on any suitable portion of refrigerator 100, such as within cabinet 120 or a door 128. In certain embodiments, the communications assembly includes a loudspeaker (e.g., dynamic loudspeaker, electrostatic loudspeaker, planar magnetic loudspeaker, piezoelectric loudspeaker etc.). As is understood, the loudspeaker may be configured to generate soundwaves from one or more electrical signals (e.g., digital sound signals received from controller 150). The loudspeaker may thus audibly communicate information to a user. In additional or alternative embodiments, the communications assembly includes a microphone (e.g., dynamic microphone, ribbon microphone, fiber-optic microphone, piezoelectric microphone, etc.). As is understood, the microphone may generate one or more electrical signals (e.g., to be received by controller 150) from one or more received soundwaves (e.g., from a user). The microphone may thus receive audible prompts or commands from a user that can be directed to the controller 150.

During use, such as during an image capture sequence, camera 160 may capture one or more two-dimensional images (e.g., as a video feed or series of sequential static images) that may be transmitted to the controller 150 (e.g., as a data signal), as is generally understood. Optionally, the image capture sequence may be initiated by a predetermined user action, such as opening a door 128, detected movement within a chilled chamber (e.g., fresh food chamber 122), engaging or moving within range of a user-detection assembly 186, proving a user input at a communications assembly 184 or integrated display 180, etc.

In exemplary embodiments, refrigerator appliance 100 includes a network interface (not shown) that couples refrigerator appliance 100 (e.g., controller 150) to a network 190 such that refrigerator appliance 100 can transmit and receive information over network 190. Network 190 can be any wired or wireless network such as a WAN, LAN, or HAN.

In optional embodiments, refrigerator appliance 100 includes a user-detection assembly 186. Generally, user-detection assembly 186 includes one or more sensors configured to detect a biometric or personalized marker corresponding to a specific individual user. As an example, user-detection assembly 186 may include a forward-facing camera configured to recognize or identify a user's face based on a captured two-dimensional image. As another example, user-detection assembly 186 may include a fingerprint imaging sensor configured to visually detect a user's fingerprint. As yet another example, user-detection assembly 186 may include a signal-detection sensor configured to detect a device address over a wireless communications band (e.g., a BLE band using short-wavelength UHF radio waves in the ISM band from 2.4 to 2.485 GHz). The device address may be a programmed Bluetooth address of, for instance, mobile display 182. The user-detection assembly 186 may thus determine if and when a mobile display 182 is within close proximity to refrigerator appliance 100.

In certain embodiments, camera 160 is included as part of user-detection assembly 186. As an example, user-detection assembly 186 may be configured to recognize or identify a user from a two-dimensional image captured at camera 160. In some such embodiments, controller 150 is further configured to recognize one or more defining features below a user's elbow, such as skin tone, arm/hand size, jewelry, typical clothing, etc. As is understood, recognizing such defining features may be performed by edge matching, divide-and-conquer search, greyscale matching, histograms of receptive field responses, or another suitable routine (e.g., executed at the controller 150 based on one or more captured images from camera 160).

In exemplary embodiments, electric locking assembly 148 is in operable communication with controller 150. As an example, the locking assembly 148 may include plunger or bolt extending from an electronic actuator to selectively be received within a corresponding recess (e.g., in a locked state) and removed from the recess (e.g., in the unlocked state), as is understood. As another example, the locking assembly 148 may include a selectively-mated electromagnet and armature plate to hold the sub-enclosure 146 in the locked state (e.g., when an active current is directed through the electromagnet) and the unlocked state (e.g., when no active current is directed through the electromagnet or a circuit thereto is otherwise opened).

Controller 150 may be configured to selectively direct locking assembly 148 to the locked and unlocked states. For instance, controller 150 may generally direct the locking assembly 148 to the locked state. In order to direct locking assembly 148 to the unlocked state, controller 150 may require a release command to be provided (e.g., by a user). In some such embodiments, the release command is provided, at least in part, by a specific user engaging user-detection assembly 186. The specific user may be predetermined and have credentials (e.g., a marker) stored within controller 150. When the specific user engages user-detection assembly 186 (e.g., as described above) a user-detection signal may be transmitted to the controller 150. Thus, controller 150 may be required to detect a specific user based on a corresponding detected marker signal received from the user-detection assembly 186.

In some embodiments, one or more remote servers 192, such as a web server, is in operable communication with controller 150. The remote server 192 can be used to host a retailer's point of sale system. In other words, remote server 192 may be or include a retailer point of sale server that tracks, for example, an identifier and quantity of purchased items (e.g., one or more medications or vitamins), a time or date stamp of purchased items, pricing of purchased items, a customer identifier (i.e., an identifier of the purchasing customer), etc. Additionally or alternatively, the remote server 192 can be used to host a retailer's stock management system. In other words, remote server 192 may include, or be provided as, a retailer stock management server that tracks, for example, stocking data relating to items offered for sale by a retailer (e.g., expiration data, location data, cost data, etc.). Also additionally or alternatively, the server can be used to host one or more information database.

The remote server 192 can be implemented using any suitable computing device(s). The remote server 192 may include one or more processors and one or more memory devices (i.e., memory). The one or more processors can be any suitable processing device (e.g., a processor core, a microprocessor, an ASIC, a FPGA, a microcontroller, etc.) and can be one processor or a plurality of processors that are operatively connected. The memory device can include one or more non-transitory computer-readable storage mediums, such as RAM, ROM, EEPROM, EPROM, flash memory devices, magnetic disks, etc., and combinations thereof. The memory devices can store data and instructions which are executed by the processor to cause remote server 192 to perform operations. For example, instructions could be instructions for receiving/transmitting point of sale data signals, receiving/transmitting inventory management data signals, receiving/transmitting data signals relating to a stored item, etc.

The memory devices may also include data, such as point of sale data, customer identification data, inventory data, etc., that can be retrieved, manipulated, created, or stored by processor. The data can be stored in one or more databases. The one or more databases can be connected to remote server 192 by a high bandwidth LAN or WAN, or can also be connected to remote server 192 through network 502. The one or more databases can be split up so that they are located in multiple locales.

Remote server 192 includes a network interface such that remote server 192 can connect to and communicate over one or more networks (e.g., network 190) with one or more network nodes. In turn, remote server 192 can exchange data with one or more nodes over the network 190. In particular, remote server 192 can exchange data with controller 150. Although not pictured, it is understood that remote server 192 may further exchange data with any number of client devices over the network 190 (e.g., mobile display 182).

Turning now to FIG. 4, a flow chart is provided of a method 400 according to exemplary embodiments of the present disclosure. Generally, FIG. 4 provides a method of operating a refrigerator appliance 100 (FIG. 1) that includes a camera 160, as described above. The method 400 can be performed, for instance, by the controller 150 (FIG. 3). For example, controller 150 may, as discussed, be in communication with camera 160, integrated display 180 (FIG. 3), mobile display 182 (FIG. 3), communications assembly 184, user-detection assembly 186, or remote server(s) 192. During operations, controller 150 may send signals to and receive signals from camera 160, integrated display 180, mobile display 182, communications assembly 184, user-detection assembly 186, locking assembly 148 or remote server(s) 192. Controller 150 may further be operatively coupled to other suitable components of the appliance 100 to facilitate operation of the appliance 100 generally.

At 410, the method 400 includes receiving a purchase invoice comprising a customer identifier. Generally, the purchase invoice may include data relating to one or more items purchased from a retailer, such as a sales receipt. As an example, the purchase invoice may include an item identifier of a purchased item (e.g., medication). The item identifier may generally or specifically indicate the type or name of the purchased item (e.g., the type of a medication). As another example, the purchase invoice may include a unit count of the purchased item. The purchased unit count may demarcate mass or discrete doses of the purchased item (e.g., the supply of a particular item). Separate from or in addition to the purchase count, the purchase invoice may include a dosing schedule detailing when or with what regularity a purchased item should be consumed. As yet another example, the purchase invoice may include a time or date stamp of a date of a purchase for a purchased item. Thus, the purchase invoice may include data indicating the time or day on which the item was purchased. As still another example, the purchase invoice may include customer identification data. Such customer identification data may be included in instances wherein a particular phone number, card, etc. of a corresponding user has been stored within a retailer's point of sale system and associated with a specific purchase.

For an illustrative example, the purchase invoice may include data that a 30 day supply of MedicationX was purchased by Customer A on July 17, wherein “MedicationX” is the item identifier, “30 day supply” is the unit count, “User A” is the customer identification data, and “July 17” is the date stamp.

In some embodiments, the purchase invoice is received directly from a retailer. For instance, the purchase invoice may be transmitted to the refrigerator appliance from a retailer point of sale server. Optionally, the retailer point of sale server may be prompted to transmit the purchase invoice upon completion of a sale to the specific refrigerator appliance if, for instance, the user has previously associated his customer identification data with the refrigerator appliance at the retailer's point of sale system. Alternatively, the retailer point of sale server may be prompted to transmit the purchase invoice in response to the user scanning a barcode on a sales receipt at a camera of the refrigerator appliance. In alternative embodiments, the sales receipt may be directly scanned by a camera of the refrigerator appliance and one or more character recognition sequences may be initiated, as would be understood, in order to interpret the text of the sales receipt (e.g., within the controller of the refrigerator appliance). The text of the sales receipt may thus be recognized and interpreted such that the controller can record (e.g., temporarily) each item detailed in the sales receipt.

Separate from or in addition to the purchase invoice, supplemental data relating to items in the purchase invoice may be received. In some embodiments, stocking data for items in the purchase invoice may be received from a stock management server. The stocking data may include, for instance, expiration data (e.g., an anticipated expiration date, emergency recall information, etc.) or location data (e.g., relating to the manufacture, supplier, or retailer).

In optional embodiments, the method 400 further includes initiating an external search for information relating to the one or more purchased items (e.g., in response to receiving the purchase invoice). For instance, a search of one or more remote servers may be initiated using an item identifier from the purchase invoice. The search may be performed across the Internet or World Wide Web (e.g., using a known search engine). Alternatively, the search may be limited to one or more predetermined web addresses, websites, or servers. Generally, the search may represent a request for information regarding a purchased item (e.g., medication), such as descriptive information, handling information, or new articles.

At 420, the method 400 includes receiving a marker signal from the user-detection assembly (e.g., subsequent to 410). As described above, the user-detection assembly may be configured to detect a biometric or personalized marker corresponding to a specific individual user. For instance, the marker may be the specific user's face, fingerprint, arm, device address, etc. While the user-detection assembly is active, data therefrom may be transmitted to, for instance, the controller of the refrigerator appliance as a marker signal.

At 430, the method 400 includes detecting the specific user based on the marker signal. In other words, the signal received from the user-detection assembly may be determined to correspond to the specific user. As described above, the detection of the specific user may include object recognition, identifying a device address, or any other suitable determination that a particular marker corresponding to the specific user is received at 420. The detection at 430 may thus indicate the specific user has engaged the user-detection assembly.

At 440, the method 400 includes determining the specific user detected at 430 corresponds to the purchase invoice. As an example, the marker of the specific user may be correlated or matched to the customer identification data within the purchase receipt. If the marker indicates the same individual (e.g., specific user) as the customer identification data, the two will thus correspond. As another example, the marker of the specific user may be correlated or matched to the item identifier. The specific user may thus correspond to all purchase invoices including a particular item (e.g., medication). Similar correlations may be made based on the retailer from which the purchase invoice originates. Additionally or alternatively, a master user may be stored within the controller such that the specific user at 420 and 430 corresponds to any received purchase invoice.

At 450, the method 400 includes directing the sub-enclosure to the unlocked state. Specifically, the sub-enclosure (e.g., the locking assembly thereof) may be directed to unlock in response to determining the specific user corresponds to the purchase invoice. In some embodiments, the sub-enclosure is only unlocked (i.e., moved to the unlocked state) in response to 440. Thus, other individuals may advantageously be restricted from accessing items, such as medications, that they have not been previously authorized to access.

Optionally, once unlocked, the sub-enclosure may remain in the unlocked state until one or more lock conditions are met. In other words, the method 400 may include determining a lock condition subsequent to 450 and directing the sub-enclosure to the locked state in response to the determined locked condition. As an example, the lock condition may include expiration of a predetermined time period (e.g., span of time) following the start of the unlocked state at 450. As another example, a lock condition may include detecting closure of the door to the chilled chamber. In other words, the sub-enclosure may be locked in response to the door being moved to the closed position.

In some embodiments, the method 400 further includes recording a descriptor of one or more items from the purchase invoice to an inventory within the refrigerator appliance (e.g., subsequent to 410). Generally, the descriptor provides text or an image relating to an item (e.g., a stored item) from the purchase invoice. Optionally, the descriptor may include stocking data (e.g., received from the stock management server), such as expiration data or location data. Once recorded, the inventory (including the descriptor of the stored item) may be selectively recalled or viewed by a user at the integrated display or mobile display to review what stored items are currently within the appliance. After the stored item is removed from the appliance, the appliance may update the inventory, for instance, automatically or in response to a manual user input, to remove the descriptor from the inventory. Additionally or alternatively, the appliance may automatically generate an alert (e.g., audio or visual alert message) at the integrated display, the mobile display, or the communications assembly in response to determining when the stored item has expired (e.g., based on the stocking data), is due to be consumed (e.g., based on the dosing schedule or date of purchase), or should be refilled (e.g., based on the unit count, dosing schedule, date of purchase, etc.).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a door being rotatably hinged to the cabinet to provide selective access to the chilled chamber;
a user-detection assembly mounted to the cabinet, the user-detection assembly being configured to detect a personalized marker corresponding to a specific individual user;
a sub-enclosure defining a storage volume and mounted to the cabinet, the sub-enclosure comprising an electric lock assembly actuatable between a locked state restricting access to the storage volume and an unlocked state permitting access to the storage volume, and
a controller operably coupled to the user-detection assembly, the controller being configured to initiate an operation routine comprising
receiving a purchase invoice,
receiving a marker signal from the user-detection assembly,
detecting a specific user based on the marker signal,
determining the specific user corresponds to the purchase invoice, and
directing the sub-enclosure to the unlocked state in response to determining the specific user corresponds to the purchase invoice.

2. The refrigerator appliance of claim 1, wherein the purchase invoice comprises a unit count of a purchased item.

3. The refrigerator appliance of claim 1, wherein the purchase invoice comprises a dosing schedule of a purchased item.

4. The refrigerator appliance of claim 1, further comprising generating an alert at the refrigerator appliance based on the dosing schedule.

5. The refrigerator appliance of claim 1, wherein the purchase invoice comprises a date stamp of a date of purchase for a purchased item.

6. The refrigerator appliance of claim 1, wherein the purchase invoice is received from a retailer point of sale server.

7. The refrigerator appliance of claim 1, wherein the operation routine further comprises receiving expiration data relating to the one or more purchased items.

8. The refrigerator appliance of claim 1, wherein the purchase invoice comprises an item identifier of a purchased item.

9. The refrigerator appliance of claim 8, wherein receiving the purchase invoice prompts an external search for information relating to the one or more purchased items.

10. The refrigerator appliance of claim 1, wherein the operation routine further comprises
determining a lock condition subsequent to directing the sub-enclosure to the unlocked state, and
directing the sub-enclosure to the locked state in response to determining the lock condition.

11. A method of operating a refrigerator appliance, the method comprising:
receiving a purchase invoice;
receiving a marker signal from a user-detection assembly of the refrigerator appliance;
detecting a specific user based on the marker signal;
determining the specific user corresponds to the purchase invoice; and
directing the sub-enclosure to the unlocked state in response to determining the specific user corresponds to the purchase invoice.

12. The method of claim 11, wherein the purchase invoice comprises a unit count of a purchased item.

13. The method of claim 11, wherein the purchase invoice comprises a dosing schedule of a purchased item.

14. The method of claim 11, further comprising generating an alert at the refrigerator appliance based on the dosing schedule.

15. The method of claim 11, wherein the purchase invoice comprises a date stamp of a date of purchase for a purchased item.

16. The method of claim 11, wherein the purchase invoice is received from a retailer point of sale server.

17. The method of claim 11, further comprising receiving expiration data relating to the one or more purchased items.

18. The method of claim 11, wherein the purchase invoice comprises an item identifier of a purchased item.

19. The method of claim 18, wherein receiving the purchase invoice prompts an external search for information relating to the one or more purchased items.

20. The method of claim 11, further comprising:
determining a lock condition subsequent to directing the sub-enclosure to the unlocked state; and
directing the sub-enclosure to the locked state in response to determining the lock condition.
